(19) United States
(12) Patent Application Publication
(10) Pub. No.: US 2015/0263934 A1
(43) Pub. Date: Sep. 17, 2015

(54) Multiple Site Route Optimization

(71) Applicant: WellAware Holdings, Inc., San Antonio, TX (US)

(72) Inventor: David Allen Sisk, San Antonio, TX (US)

(21) Appl. No.: 14/631,569

(22) Filed: Feb. 25, 2015

Related U.S. Application Data
(60) Provisional application No. 61/952,638, filed on Mar. 13, 2014.

(51) Int. Cl. H04L 12/721; H04W 40/12

(52) U.S. Cl. CPC H04L 45/124; H04W 40/125

(57) ABSTRACT

Implementations of the present disclosure include methods, systems, and computer-readable storage mediums for providing a route between sites. Actions can include receiving a set of operators, receiving one or more sets of operator parameters, each set of operator parameters corresponding to a respective operator of the set of operators, receiving sets of site parameters, each set of site parameters corresponding to a respective site of a set of sites, and for each operator of the set of operators: determining a set of potential routes based on a respective set of operator parameters and the sets of site parameters, each potential route of the set of potential routes being associated with a respective cost, and assigning a route of the set of potential routes to a respective operator based on at least one cost.

### CROSS-REFERENCE TO RELATED APPLICATIONS

This application claims priority to U.S. Provisional Application Ser. No. 61/952,638, filed on Mar. 13, 2014, which is expressly incorporated herein by reference.

### BACKGROUND

Enterprises can include multiple sites, between which, personnel travel. For example, oil and gas operations can include multiple well-sites, between which operators travel (e.g., to perform maintenance). In some instances, an operator has a static route that they travel in a given day. In some instances, a route is assigned to an operator each day and can change from day-to-day. In some instances, an operator is required to detour from an assigned route to attend to an unexpected event. Each of these examples can result in inefficient use of both human (e.g., operators) and machine (e.g., equipment at the well-sites) resources.

### SUMMARY

Implementations of the present disclosure include computer-implemented methods for providing routes between sites, such as well-sites. In some implementations, actions include receiving a set of operators, receiving one or more sets of operator parameters, each set of operator parameters corresponding to a respective operator of the set of operators, receiving sets of site parameters, each set of site parameters corresponding to a respective site of a set of sites, and, for each operator of the set of operators: determining a set of potential routes based on a respective set of operator parameters and the sets of site parameters, each potential route of the set of potential routes being associated with a respective cost, and assigning a route of the set of potential routes to a respective operator based on costs. Other implementations include corresponding systems, apparatus, and computer programs, configured to perform the actions of the methods, encoded on computer storage devices.

These and other implementations can each optionally include one or more of the following features: operator parameters include one or more of a role, a skill set, a location, qualifications, and experience; site parameters include one or more of site location, site type, site equipment, site tasks, and site histories; one or more potential routes are provided based on ancillary information; ancillary information includes weather information; assigning a route of the set of potential routes to a respective operator based on costs includes: determining a local optimization, and assigning the route based on the local optimization; the local optimization includes identifying the route as being associated with a minimum cost in the set of potential routes; assigning a route of the set of potential routes to a respective operator based on costs includes: determining a global optimization, and assigning the route based on the global optimization; the global optimization includes identifying the route as contributing to a minimum cost across all assigned routes; actions further include transmitting data and instructions to display a representation of the route on a device; actions further include receiving data indicating progress along the route; the route of the set of potential routes is provided as a modified route in response to determining that one or more events have occurred; a cost associated with a potential route is based on one or more parameters of the set of operator parameters associated with the respective operator; costs are respectively provided as one or more of temporal cost and monetary cost; and the set of available operators includes one or more operators.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system in accordance with implementations of the present disclosure.

FIG. 2 depicts an example portion of a play network.

FIG. 3 depicts a representation of an example well-site.

FIGS. 4A-4C depict example screen-shots in accordance with implementations of the present disclosure.

FIG. 5 depicts an example processes that can be executed in accordance with implementations of the present disclosure.

Like reference symbols in the various drawings indicate like elements.

### DETAILED DESCRIPTION

Implementations of the present disclosure are generally directed to providing routes to be traveled by one or more personnel between sites, such as well-sites. In some examples, the routes include optimized routes. In some implementations, a route is determined for a respective operator based on one or more costs. Example costs can include monetary cost, and temporal cost. In some examples, the route can be optimized such that a cost associated with the route is minimized. For example, the route can be provided to minimize monetary cost and/or temporal cost. In some examples, and as discussed in further detail herein, cost can be optimized on a per-route basis. In some examples, and as also discussed in further detail herein, cost can be optimized across a plurality of routes.

In some implementations, one or more events can occur, which require one or more personnel to be re-routed. For example, one or more events can occur that require an operator to deviate from an initial route (e.g., change an order of the sites that are to be visited, include one or more additional sites to be visited, remove one or more sites from the route). In some implementations, in response to the one or more events, a modified route is determined for the operator. In accordance with implementations of the present disclosure, the modified route can be optimized based on cost (e.g., monetary cost, temporal cost).

Implementations of the present disclosure can increase the efficiency of well-site operations, including use of human (e.g., personnel) and machine (e.g., equipment at a site) resources. For example, implementations of the present disclosure can improve equipment and operation thereof by optimally routing appropriately-skilled operators to attend to the equipment. In some examples, if an operator attends to equipment in sufficient time (e.g., before the equipment becomes inoperable/unrepairable), the equipment can be repaired and put back into operation. Accordingly, implementations of the present disclosure can inhibit occurrences of an operator not attending to equipment in sufficient time, resulting in, for example, loss of the equipment and a need to replace the equipment. In this manner, implementations of the present disclosure provide improvements to underlying technology.

Implementations of the present disclosure will be discussed in further detail with reference to an example context. The example context includes oil and gas well-sites. It is appreciated, however, that implementations of the present disclosure can be realized in other appropriate contexts, e.g., a chemical plant, a fertilizer plant, tank batteries (located away from a site), above-ground appurtenances (pipelines) and/or intermediate sites. An example intermediate site can include a central delivery point that can be located between a site and a refinery, for example. Within the example context, implementations of the present disclosure are discussed in further detail with reference to an example sub-context. The example sub-context includes a production well-site. It is appreciated, however, that implementations of the present disclosure can be realized in other appropriate sub-contexts, e.g., an exploration well-site, a configuration well-site, an injection well-site, an observation well-site, and a drilling well-site.

In the example context and sub-context, well-sites can be located in natural resource plays. A natural resource play can be associated with oil and/or natural gas. In general, a natural resource play includes an extent of a petroleum-bearing formation, and/or activities associated with petroleum development in a region. An example geographical region can include southwestern Texas in the United States, and an example natural resource play includes the Eagle Ford Shale Play.

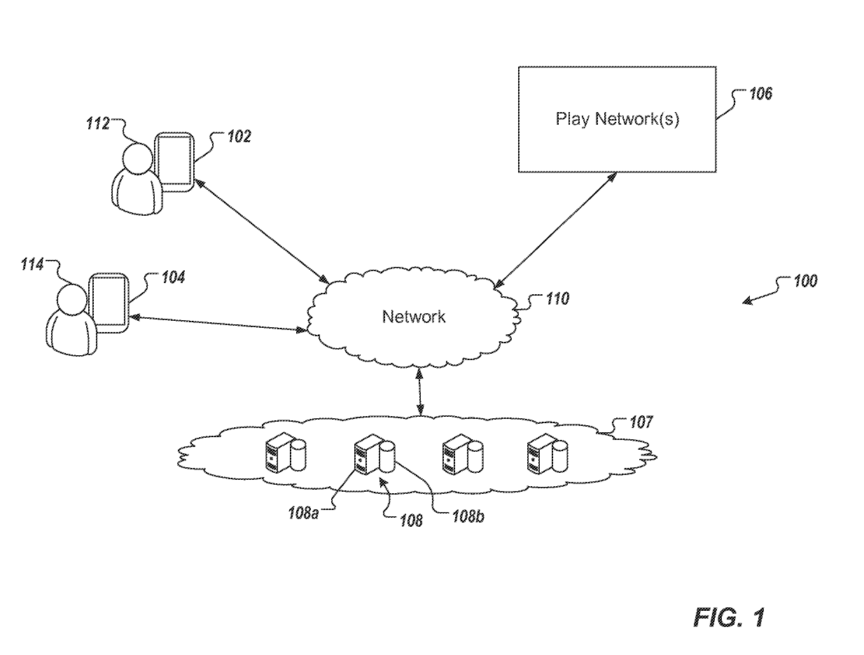

FIG. 1 depicts an example system 100 that can execute implementations of the present disclosure. The example system 100 includes one or more computing devices, such as computing devices 102, 104, one or more play networks 106, and a computing cloud 107 that includes one or more computing systems 108. The example system 100 further includes a network 110. The network 110 can include a large computer network, such as a local area network (LAN), wide area network (WAN), the Internet, a cellular network, a satellite network, a mesh network, e.g., 900 Mhz, one or more wireless access points, or a combination thereof connecting any number of mobile clients, fixed clients, and servers. In some examples, the network 110 can be referred to as an upper-level network.

The computing devices 102, 104 are associated with respective users 112, 114. In some examples, the computing devices 102, 104 can each include various forms of a processing device including, but not limited to, a desktop computer, a laptop computer, a tablet computer, a wearable computer, a handheld computer, a personal digital assistant (PDA), a cellular telephone, a network appliance, a smart phone, an enhanced general packet radio service (EGPRS) mobile phone, or an appropriate combination of any two or more of these example data processing devices or other data processing devices. The computing systems 108 can each include a computing device 108a and computer-readable memory provided as a persistent storage device 108b, and can represent various forms of server systems including, but not limited to a web server, an application server, a proxy server, a network server, or a server farm.

In some implementations, and as discussed in further detail herein, site data (e.g., oil data and/or gas data) can be communicated from one or more of the play networks 106 to the computing systems 108 over the network 110. In some examples, each play network 106 can be provided as a regional network. For example, a play network can be associated with one or more plays within a geographical region. In some examples, each play network 106 includes one or more sub-networks. As discussed in further detail herein, example sub-networks can include a low power data sub-network, e.g., a low power machine-to-machine data network (also referred to as a smart data network and/or an intelligent data network, one or more wireless sub-networks, and mesh sub-networks, e.g., 900 Mhz.

In some examples, the computing systems 108 store the well data and/or process the well data to provide auxiliary data. In some examples, the well data and/or the auxiliary data are communicated over the play network(s) 106 and the network 110 to the computing devices 102, 104 for display thereon. In some examples, user input to the computing devices 102, 104 can be communicated to the computing systems 108 over the network 110.

In general, monitoring of well sites can include oil well monitoring and natural gas well monitoring (e.g., pressure(s), temperature(s), flow rate(s)), compressor monitoring (e.g., pressure, temperature), flow measurement (e.g., flow rate), custody transfer, tank level monitoring, hazardous gas detection, remote shut-in, water monitoring, cathodic protection sensing, asset tracking, water monitoring, access monitoring, and valve monitoring. In some examples, monitoring can include monitoring the presence and concentration of fluids (e.g., gases, liquids). In some examples, control capabilities can be provided, such as remote valve control, remote start/stop capabilities, remote access control.

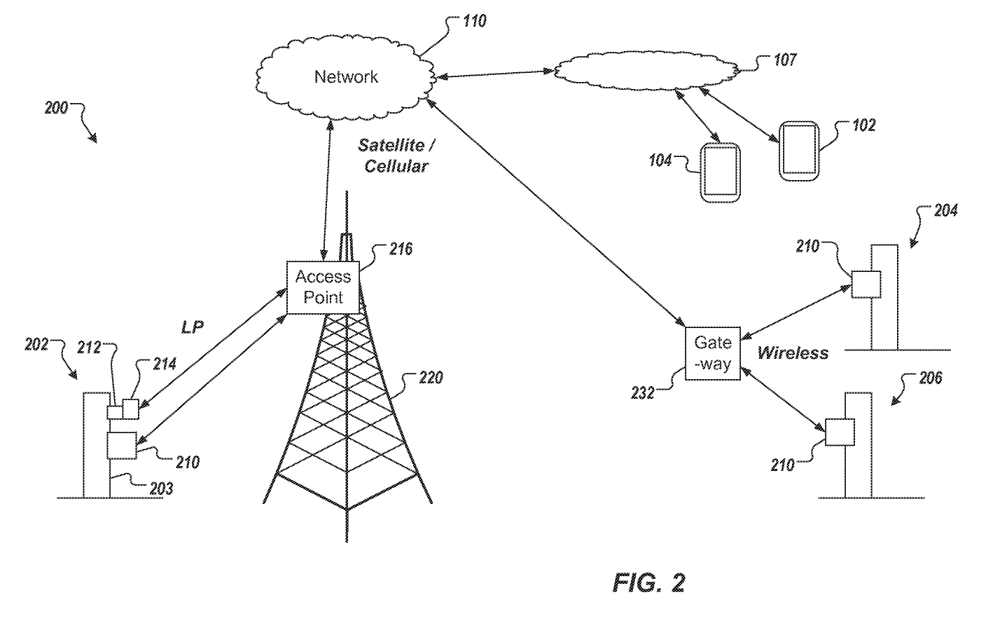

FIG. 2 depicts an example portion of an example play network 200. The example play network 200 provides low power (LP) communication, e.g., using a low power data network, and cellular and/or satellite communication for well data access and/or control. In some examples, as discussed herein, LP communication can be provided by a LP network. In the example of FIG. 2, a first well site 202, a second well site 204 and a third well site 206 are depicted. Although three well sites are depicted, it is appreciated that the example play network 200 can be associated with any appropriate number of well sites. In the example of FIG. 2, well monitoring and data access for the well site 202 is provided by the play network 200 using LP communication and cellular and/or satellite communication, and well monitoring and data access for the well sites 204, 206 is provided by the play network 200 using cellular, satellite, and/or mesh network communication.

The example of FIG. 2 corresponds to the example context and sub-context (a production well-site) discussed above. It is appreciated, however, that implementations of the present disclosure are applicable in any appropriate context. In the depicted example, the well site 202 includes a wellhead 203, a sensor system 210, a sensor system 212 and communication device 214. In some examples, the sensor system 210 includes a wireless communication device that is connected to one or more sensors, the one or more sensors monitoring parameters associated with operation of the wellhead 203. In some examples, the wireless communication device enables monitoring of discrete and analog signals directly from the connected sensors and/or other signaling devices. In some examples, the sensor system 210 can provide control functionality (e.g., valve control). Although a single sensor system 210 is depicted, it is contemplated that a well site can include any appropriate number of sensor systems 210. In some examples, the sensor system 212 includes one or more sensors that monitor parameters associated with operation of the wellhead 203. In some examples, the sensor system 212 generates data signals that are provided to the communication device 214, which can forward the data signals. Although a single sensor system 212 and communication device 214 are depicted, it is contemplated that a well site can include any appropriate number of sensor systems 212 and/or communication devices 214.

Well data and/or control commands can be provided to/from the well site 202 through an access point 216. More particularly, information can be transmitted between the access point 216, the sensor system 210, and/or the communication device 214 based on LP. In some examples, LP provides communication using a globally certified, license free spectrum (e.g., 2.4 GHz). In some examples, the access point 216 provides a radial coverage that enables the access point 216 to communicate with numerous well sites, such as the well site 202. In some examples, the access point 216 further communicates with the network 110 using cellular, satellite, mesh, point-to-point, point-to-multipoint radios, and/or terrestrial or wired communication.

In the depicted example, the access point 216 is mounted on a tower 220. In some examples, the tower 220 can include an existing telecommunications or other tower. In some examples, an existing tower can support multiple functionalities. In this manner, erection of a tower specific to one or more well sites is not required. In some examples, one or more dedicated towers could be erected.

In the depicted example, the well sites 204, 206 include respective wellheads 205, 207, and respective sensor systems 210 (discussed above). Although a single sensor system 210 is depicted for each well site 204, 206, it is contemplated that a well site can include any appropriate number of sensor systems 210. In some examples, well data and/or control commands can be provided to/from the well sites 202 through a gateway 232. More particularly, information can be transmitted between the gateway 232, and the sensor systems 210 can be wireless communication (e.g., radio frequency (RF)). In some examples, the gateway 232 further communicates with the network 110 using cellular and/or satellite communication.

In accordance with implementations of the present disclosure, well site control and/or data visualization and/or analysis functionality (e.g., hosted in the computing cloud 107 of FIGS. 1 and 2) and one or more play networks (e.g., the play networks 106, 200 of FIGS. 1 and 2) can be provided by a service provider. In some examples, the service provider provides end-to-end services for a plurality of well sites. In some examples, the service provider owns the one or more play networks and enables well site operators to use the play networks and control/visualization/monitoring functionality provided by the service provider. For example, a well site operator can operate a plurality of well sites (e.g., the well sites 202, 204, 206). The well site operator can engage the service provider for well site control/visualization/monitoring services (e.g., subscribe for services) through a play network (e.g., the play network 200). In some examples, the service provider and/or the well site operator can install appropriate sensor systems, communication devices and/or gateways (e.g., as discussed above with reference to FIG. 2). In some examples, sensor systems, communication devices and/or gateways can be provided as end-points that are unique to the well site operator.

In some implementations, the service provider can maintain one or more indices of end-points and well site operators. In some examples, the index can map data received from one or more end-points to computing devices associated with one or more well site operators. In some examples, well site operators can include internal server systems and/or computing devices that can receive well data and/or auxiliary data from the service provider. In some examples, the service provider can receive messages from well sites, the messages can include, for example, well data and an end-point identifier. In some examples, the service provider can route messages and/or auxiliary data generated by the server provider (e.g., analytical data) to the appropriate well site operator or personnel based on the end-point identifier and the index. Similarly, the service provider can route messages (e.g., control messages) from a well site operator to one or more appropriate well sites.

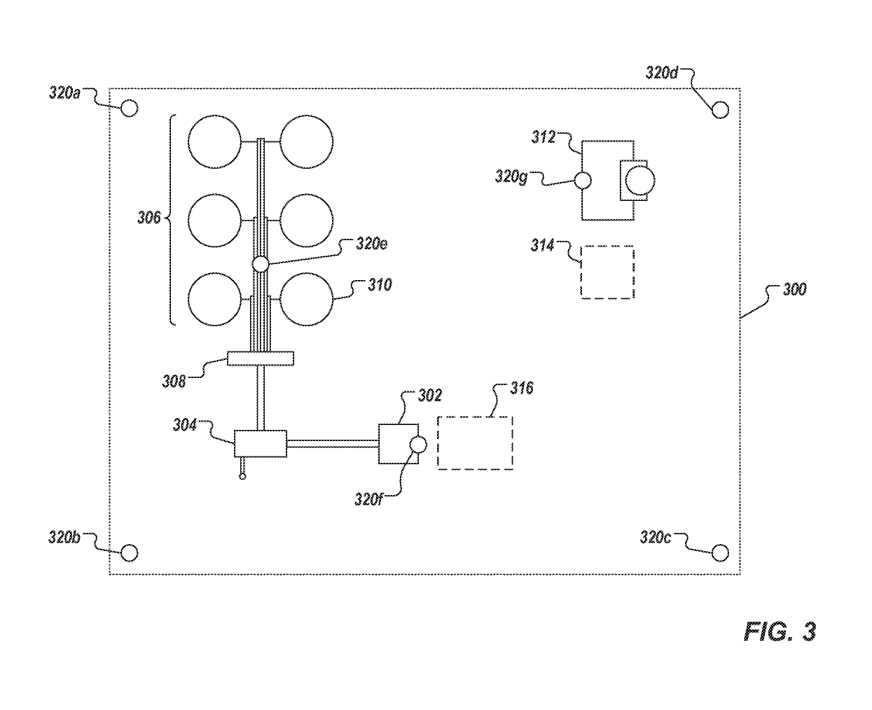

FIG. 3 depicts a representation of an example well-site 300. The example well-site 300 can include a production well-site, in accordance with the example sub-context provided above. In the depicted example, the well-site 300 includes a well-head 302, an oil and gas separator 304 and a storage tank system 306. In the depicted example, the storage tank system 306 includes a manifold 308 and a plurality of storage tanks 310. The example well-site 300 further includes a base station 312. In some examples, the well-site 300 can include a local weather station 314. In some examples, the well-site 300 can include artificial lift equipment 316 (e.g., to assist in extraction of oil and/or gas from the well).

In some examples, the well-site 300 includes one or more sensors 320a-320g. In some examples, each sensor 320a-320g can be provided as a single sensor. In some examples, each sensor 320a-320g can be provided as a cluster of sensors, e.g., a plurality of sensors. Example sensors can include fluid sensors, e.g., gas sensors, temperature sensors, and/or pressure sensors. Each sensor 320a-320g is responsive to a condition, and can generate a respective signal based thereon. In some examples, the signals can be communicated through a network, as discussed above with reference to FIG. 2. In some examples, the signals can be communicated to a chart recorder, which can draw traces on a chart in response to signals, as discussed herein.

With continued reference to FIG. 3, sensors 320a-320g can include temperature sensors and/or pressure sensors. For example, the sensors 320a-320g can be responsive to the temperature and/or pressure of a fluid. That is, the sensors 320a-320g can generate respective signals that indicate the temperature and/or pressure of a fluid. As discussed herein, data from the sensors 320a-320g can be provided to a back-end system for processing. For example, data can be provided through a play network, e.g., the play network(s) 106 of FIG. 1, to a computing cloud, e.g., the computing cloud 107. As also discussed herein, signals from one or more sensors can be provided to a chart recorder, which can draw traces on a chart in response to the signals.

As introduced above, implementations of the present disclosure are directed to providing routes traveled by one or more personnel between sites, such as well-sites. More particularly, implementations of the present disclosure provide optimized routes that include a list of sites to be visited during a specified time period (e.g., day), and an order, in which the sites are to be visited. In some examples, for each site in the list of sites, a list of tasks to be performed at each site can also be provided. In accordance with implementations of the present disclosure, respective routes can be communicated to in-field personnel (e.g., operators that visit the sites and perform tasks). For example, routes can be determined by a back-end system (e.g., the computing cloud 107), and can be transmitted to respective computing devices (e.g., the computing devices 102, 104). In some examples, operators (e.g., the users 112, 114) can view their respective routes using the computing devices 102, 104. In some examples, routes can be displayed as a series of waypoints on an interactive map. In some examples, routes can be displayed in tabular form.

In some implementations, initial routes are determined for each operator of a plurality of operators. In some examples, the plurality of operators include operators that are available for site visits for a given time period (e.g., day, week, month). In some examples, the initial routes are manually determined (e.g., by a supervisor). In some examples, the initial routes are automatically determined (e.g., by the computing cloud 107 of FIG. 1), as discussed herein.

In accordance with implementations of the present disclosure, routes (e.g., initial routes, modified routes) can be provided as optimized routes. In some examples, route optimization includes minimizing individual costs associated with respective routes, and/or total cost across all routes. As introduced above, example costs can include monetary costs and temporal costs.

In some implementations, routes are determined based on one or more operator parameters associated with operators of the plurality of operators. Example operator parameters can include a role of the person (e.g., field supervisor, gauger, maintenance), a skill set of the person, a location of the person (e.g., GPS coordinates), qualifications of the person, and experience of the person. In some implementations, routes are determined based on one or more site parameters associated with sites of a plurality of sites that are to be visited for the given time period (e.g., day, week, month). Example site parameters can include site location (e.g., GPS coordinates), site type (e.g., drilling, production, exploration), equipment located at the site, tasks that are to be performed during the visit (e.g., data recording, maintenance), site histories (e.g., maintenance history). In some examples, ancillary information can be provided, and can be used to determine routes. Example ancillary information can include weather information (e.g., local weather at each of the sites, regional weather, current weather conditions, forecast weather conditions).

In some implementations, a plurality of potential sites can be determined for each operator. In some examples, potential sites included in the plurality of sites can be determined based on operator parameters and site parameters. For example, a particular site can include a set of site parameters, and the particular operator can include a set of operator parameters associated therewith. In some examples, site parameters of the set of site parameters can be compared to respective operator parameters of the set of operator parameters. If, based on the comparison, the site parameters match the operator parameters, it is determined that the particular operator is appropriate for attending to the particular site (e.g., the operator has the required role and/or sufficient skills/experience to perform tasks required at the site), and the particular site is included as a potential site in the plurality of potential sites. If, based on the comparison, the site parameters do not match the operator parameters, it is determined that the particular operator is not appropriate for attending to the particular site (e.g., the operator does not have the required role and/or sufficient skills/experience to perform tasks required at the site), and the particular site is not included as a potential site in the plurality of potential sites.

In some implementations, for each operator, a set of potential routes is determined for potential sites of the set of potential sites. In some examples, potential routes can be determined based on distance between potential sites. In some examples, potential routes can be determined based on the last site on the potential route being within a threshold distance of the first site on the potential route (e.g., such that the operator ends the route near where the route started). In some examples, potential routes can be determined based on time required at respective sites. For example, tasks required to be performed at one site can require more time than tasks to be performed at another site. In some examples, time required to perform tasks can be determined based on the skills and/or experience of the particular operator (e.g., a more experienced operator may require less time than a less experienced operator). In some examples, potential routes can be determined based on weather. For example, weather information can indicate inclement weather (e.g., that affects ability to perform tasks) at a site at a first time, and non-inclement weather (e.g., that does not affect ability to perform tasks) at a second time. Consequently, potential routes can order the site, such that it is visited at or near the second time, but not the first time.

In some implementations, one or more costs are determined for each potential route in the set of potential routes. In some examples, a temporal cost can be determined for each potential route. In some examples, the temporal cost can be determined based on time required to travel between sites of the potential route, and/or time required to perform required tasks at the respective sites. In some examples, monetary cost can be determined based on distance and/or terrain between sites (e.g., fuel cost to travel the potential route), and/or operator cost (e.g., a more experienced operator can cost more than a less experienced operator, an operator having a role with greater responsibility/authority can cost more than an operator having a role with lesser responsibility/authority). It is appreciated that temporal cost and/or monetary cost can be determined on any appropriate combination of factors including factors not explicitly addressed herein.

In some implementations, a combined cost can be determined for each potential route of the set of potential routes. In some examples, the combined cost can include a combination of the temporal cost and the monetary cost. In some examples, the combined cost can be a simple sum of the temporal cost and the monetary cost. In some examples, the combined cost can be a weighted sum of the temporal cost and the monetary cost (e.g., the temporal cost and/or the monetary cost is/are weighted to adjust respective influences in determining the combined cost).

In some implementations, a route is selected for each operator from the respective set of potential routes. In some examples, the route is selected on a per-route basis, such that the cost is minimized for the respective operator (e.g., local optimization). For example, for a particular operator, the selected route is associated with a minimal cost (e.g., temporal cost, monetary cost, combined cost) of the potential routes in the respective set of potential routes. In some examples, the route is selected across all routes of all operators, such that the total cost across all routes is minimized (e.g., global optimization). For example, for a particular operator, the selected route contributes to minimizing total cost across all routes selected for all operators, although the selected operator might not be the lowest cost route in the respective set of potential routes.

Implementations of the present disclosure will be discussed with reference to a first operator and a second operator, for which a first route and a second route are to be respectively determined, from a set of sites. It is appreciated, however, that implementations of the present disclosure can be used to provide optimized routes for any appropriate number of operators.

In accordance with implementations of the present disclosure, a first set of potential routes can be determined for the first operator based on operator parameters associated with the first operator and site parameters associated with sites of the set of sites. In some implementations, each potential route in the first set of potential routes is associated with a respective cost (e.g., monetary cost and/or temporal cost). A second set of potential routes can be determined for the second operator based on operator parameters associated with the second operator and site parameters associated with sites of the set of sites. In some implementations, each potential route in the second set of potential routes is associated with a respective cost (e.g., monetary cost and/or temporal cost).

In some examples, potential routes of the first set of potential routes affect potential routes and associated costs of the second set of potential routes, and potential routes of the second set of potential routes affect potential routes and associated costs of the first set of potential routes. For example, a particular site can be included in a potential route of the first set of potential routes and be absent from a potential route of the second set of potential routes (e.g., the first operator is scheduled to visit the particular site, so the second operator is not scheduled to visit the particular site). As another example, the particular site can be absent from a potential route of the first set of potential routes, but can be included in a potential route of the second set of potential routes (e.g., the second operator is scheduled to visit the particular site, so the first operator is not scheduled to visit the particular site). As another example, the particular site can be included in a potential route of the first set of potential routes, and can also be included in a potential route of the second set of potential routes (e.g., both the first operator and the second operator are scheduled to visit the particular site, either at the same time or at different times).

In some implementations, a first route is selected from the first set of potential routes, the first route defining sites that are to be visited by the first operator, and a second route is selected from the second set of potential routes, the second route defining sites that are to be visited by the second operator. In some implementations, the first route and the second route are selected to minimize individual costs (e.g., per-route, or local optimization). For example, the first route can be selected, because the cost associated therewith is the minimum cost of the routes of the first set of routes, and the second route can be selected, because the cost associated therewith is the minimum cost of the routes of the second set of routes. In some implementations, the first route and the second route are selected to minimize overall costs (e.g., multi-route, or global optimization). For example, the first route can be selected, because the cost associated therewith helps minimize the total cost of the all of the assigned routes, even though the first route is not associated with the minimum cost of the first set of routes. For example, selection of the first route can result in a reduction in cost of the second route, such that the total cost of the first route and the second route is less than it otherwise would be.

In some implementations, each operator's progression through their respective route can be monitored. For example, as an operator progresses through their route, data can be provided to a back-end system (e.g., the computing cloud 107 of FIG. 1), which can process the data to provide a route progress for the respective route. In some examples, data can include check-in data and/or GPS data indicating that the operator indeed visited a particular site, and respective arrival time at the site and departure time from the site. In some examples, data can include operator-provided input indicating that one or more tasks were performed. For example, the operator can provide input to a task checklist provided on a computing device (e.g., the computing device 102, 104 of FIG. 1) indicating tasks performed. In some examples, data can include sensor-provided data indicating that one or more tasks were performed. For example, sensor readings can change in response to the operator performing a task, the change in sensor reading indicating that the task was actually performed. In some implementations, conditions at sites can be monitored. In some examples, sensors (e.g., the sensors 320a-320g of FIG. 3) can provide data to the back-end system, which can process the data to determine conditions at the site.

In accordance with implementations of the present disclosure, one or more events can occur as operators progress through their respective routes, which can require one or more operators to deviate from their route(s). More particularly, one or more events can occur, which initiate determination of a modified route for one or more operators. Example events can include a condition at one or more sites that require(s) immediate attention (e.g., an emergency condition), an operator being unable to continue a route (e.g., vehicle breakdown), an operator requiring more time at a site than estimated, an operator becoming available to visit sites (e.g., an operator finishing their route early, and being able to visit a site along the route of another operator), and weather conditions that affect whether a site can be visited and/or tasks at the site being able to be performed. It is appreciated that the example events provided above are not exhaustive of events that can occur and result in modified route(s) being required.

In some implementations, the back-end system (e.g., the computing cloud 107 of FIG. 1) can recognize the occurrence of an event based on data received from the sites (e.g., from the sensors 320a-320g of FIG. 3) and/or operators (e.g., through the computing device 102, 104 of FIG. 1). In some examples, and in response to recognizing the occurrence of the event, the back-end system can automatically determine a modified route. In some examples, an operator can recognize the occurrence of an event, and can provide an indication to the back-end system. For example, the operator may become aware of a personal emergency that the operator must attend to, and can provide an indication (e.g., to the back-end system) that they are unable to continue along the route. In some examples, and in response to being informed of the occurrence of the event, the back-end system can automatically determine a modified route.

In some implementations, and as discussed in further detail herein, one or more modified routes can be determined for respective operators in response to the one or more events. In some implementations, each modified route can be determined as discussed above (e.g., determine a set of operators, determine a set of sites, determine a set of potential sites for each operator, determine a set of potential routes for each operator, and select a modified route from the set of potential routes). In some examples, the set of operators, for which a modified route is to be determined, can include operators that are affected by the one or more events. For example, an operator can be affected by an event, if the operator is unable to visit a site along their route (e.g., vehicle malfunction, inclement weather), if a condition at a site that is not on the operator's route requires the operator to attend to (e.g., the operator has particular skills/experience to attend to a condition at a site that is not on the operator's current route), if the operator spends too much time at a site along their route, among other possible reasons.

In some examples, the set of potential sites, for which a modified route is to be determined, can include sites that are affected by the one or more events. For example, a site can be affected, if the scheduled operator is unable to visit the site (e.g., vehicle malfunction, inclement weather), if a condition occurs at the site (e.g., the condition requires immediate attention, and/or an operator that has particular skills/experience is required to attend to the condition), if the scheduled operator spends too much time at another site and the visit to the site is delayed, among other possible reasons.

In some examples, and as discussed above, a set of potential routes (e.g., modified routes) can be determined for each affected operator of the set of operators, and one or more costs (e.g., monetary cost and/or temporal cost) can be provided for each potential route. In some examples, and as also discussed above, a modified route can be selected for each operator from the respective sets of potential routes (e.g., based on local optimization, or global optimization).

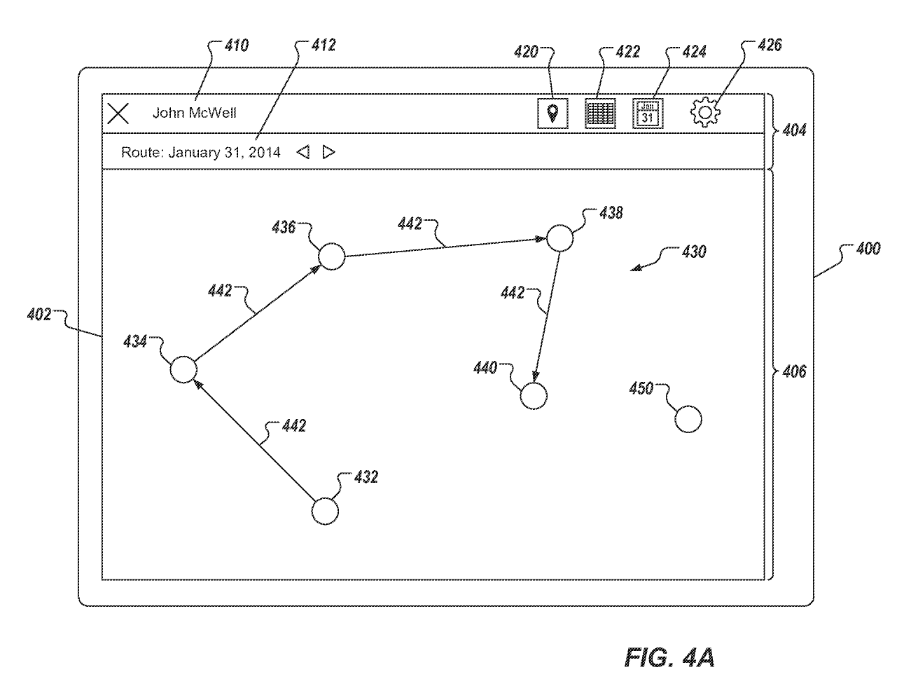

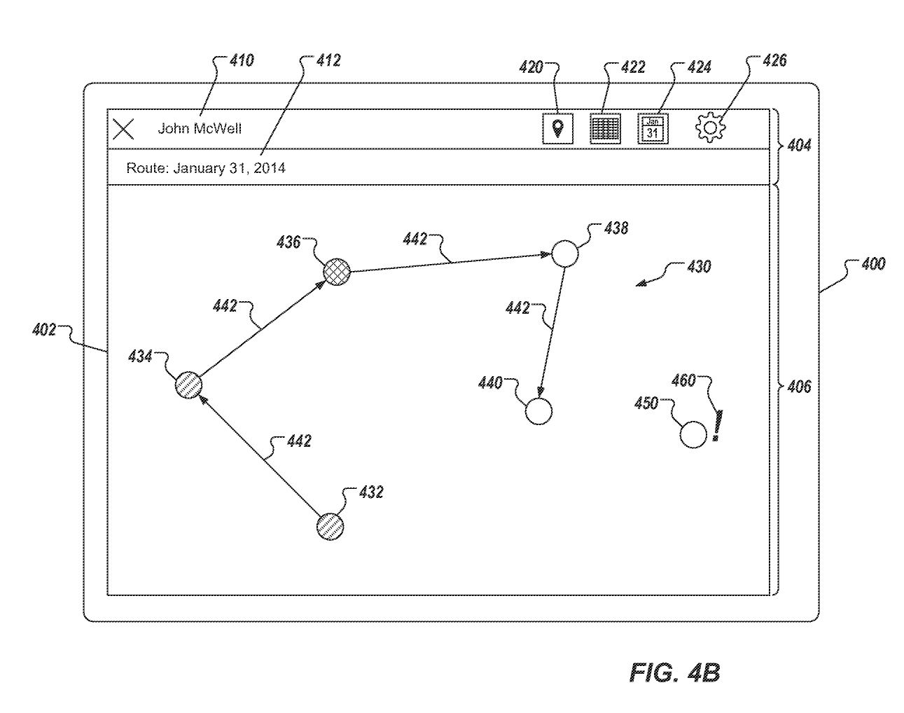

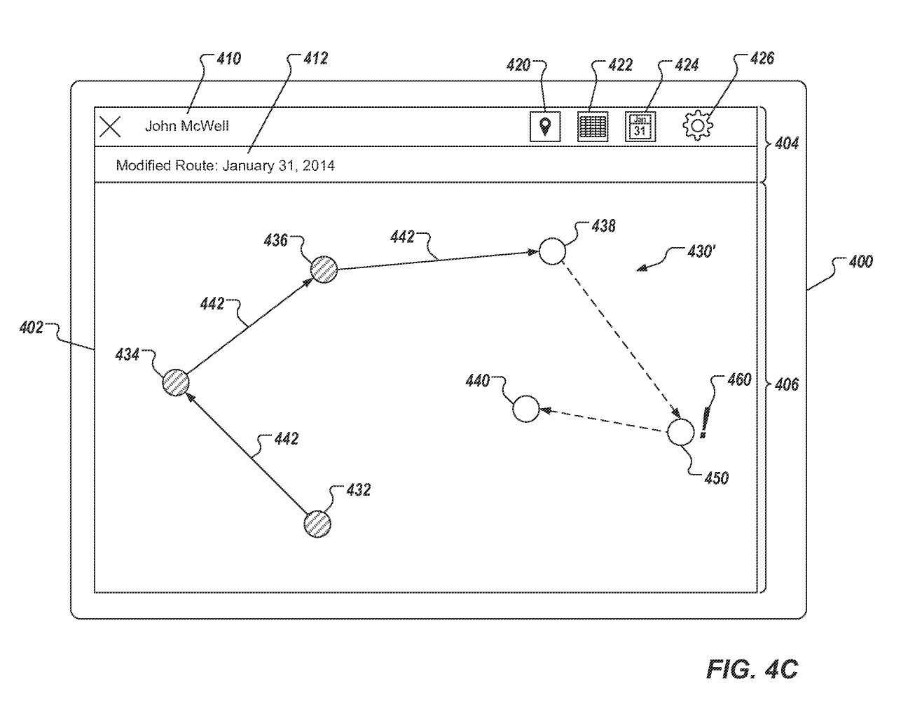

FIGS. 4A-4C depict example screen-shots in accordance with implementations of the present disclosure. FIG. 4A depicts a device 400 displaying an example route interface 402. In the depicted example, the route interface 402 includes an information frame 404 and a route frame 406. In some examples, the information frame 404 provides information that is pertinent to a route depicted in the route frame 406. In the depicted example, the information frame 404 provides an operator identifier 410 (e.g., provided as an operator's name) and a route date 412 (e.g., the date, on which the route is to be traveled by the identified operator). It is appreciated that the information frame 404 can provide any appropriate information.

In the depicted example, the information frame 404 includes a map icon 420, a table icon 422, a calendar icon 424, and a settings icon 426. In some examples, the map icon 420 can be selected to display a subject route in map-form within the route frame 406. In the depicted example, the map icon 420 is selected. In some examples, the table icon 422 can be selected to display the subject route in table-form within the route frame. In some examples, the subject route can be concurrently displayed (e.g., split-screen) in map-form and table-form within the route frame 406. In some examples, the calendar icon 424 can be selected to display a calendar (e.g., daily, weekly, monthly) in the route frame 406. For example, the calendar can be displayed, and the route date can be selected from the calendar.

In some examples, the route interface 402 is displayed to an assigned operator. For example, a fictional operator “John McWell” can be a user of the device 400 and can be assigned to one or more routes that can be displayed in the route interface. In some examples, the route interface 402 is displayed to a supervisor. For example, a supervisor can be a user of the device 400 and can monitor one or more operators that are assigned to routes.

As introduced above, the route frame 406 depicts a route (e.g., in map-form and/or table form). In the depicted example, an example route 430 is depicted in map-form. The example route 430 includes site representations 432, 434, 436, 438, 440 (e.g., well-sites) that are to be visited on the route 430. In the depicted example, arrows 442 depict an order that the site representations 432, 434, 436, 438, 440 are to be visited in. In the depicted example, the arrows 442 are provided as straight lines. In some examples, a path between sites can be provided as one or more lines. For example, a path can be displayed that overlays known pathways (e.g., roads) between sites. Although not depicted, implementations of the present disclosure can provide navigation instructions between sites (e.g., a path between sites depicted between displayed sites, and/or visual/audible guidance for travel between sites).

In the depicted example, a site representation 450 is also depicted, but is not included in the route 430. In some examples, the site representation 450 can represent a site that is not being visited on the route date. In some examples, the site representation 450 can represent a site that is being visited by another operator on the route date.

FIG. 4B depicts the route interface 402 as the assigned operator progresses through the route 430. In some examples, and as discussed above, data can be provided to a back-end system (e.g., the computing cloud 107 of FIG. 1), which can process the data to provide a route progress for the respective route. In some examples, data can include check-in data and/or GPS data indicating that the operator indeed visited a particular site, and respective arrival time at the site and departure time from the site. In some examples, data can include operator-provided input indicating that one or more tasks were performed. For example, the operator can provide input to a task checklist, which can be displayed in the route interface 402, indicating tasks performed. In some examples, data can include sensor-provided data indicating that one or more tasks were performed. For example, sensor readings can change in response to the operator performing a task, the change in sensor reading indicating that the task was actually performed. In some implementations, conditions at sites can be monitored. In some examples, sensors (e.g., the sensors 320a-320g of FIG. 3) can provide data to the back-end system, which can process the data to determine conditions at the site.

In some implementations, a parameter associated with the site representations can be changed in response to a visit and/or completion of a visit. Example parameters can include shape, color, and indicator associated with the site representation. In the depicted example, the operator has completed visits to the sites represented by the site representations 432, 434. Consequently, a color of the site representations 432, 434 has been changed. In the depicted example, the operator is currently at the site represented by the site representation 436. Consequently, a color of the site representation 436 has been changed.

In some implementations, and as discussed herein, one or more events can occur that result in modification of a route. In the depicted example, it can be determined that an event has occurred that affects the site represented by the site representation 450. In some examples, and in response to occurrence of one or more events, a parameter associated with the site representation can be changed. Example parameters can include shape, color, and indicator associated with the site representation. In the depicted example, an exclamation 460 has been associated with the site representation 450.

In some implementations, and as discussed herein, a modified route can be provided in response to occurrence of the one or more events. FIG. 4C depicts a modified route 430′ displayed in the route interface 402. In the depicted example, the route 430 has been modified to provide the modified route 430′, which includes the site represented by the site representation 450. For example, it can be determined that the operator that was previously scheduled to visit the site represented by the site representation 450 is unable to visit the site. Consequently, the operator assigned to the route 430 can be tasked with visiting the site. As another example, it can be determined that a condition has arisen at the site represented by the site representation 450, which condition requires the skills, experience and/or expertise of the operator assigned to the route 430. Consequently, the operator can be tasked with visiting the site.

In accordance with implementations of the present disclosure, the modified route 430′ is provided as an optimized route. For example, it can be determined that tasking the operator assigned to the route 430 to also visit the site represented by the site representation 450 minimizes cost (e.g., temporal and/or monetary), as opposed to tasking another operator with the visit. As another example, it can be determined that the order of the modified route 430′ minimizes cost (e.g., temporal and/or monetary), as opposed to other possible orders (e.g., visiting the site immediately from the site represented by the site representation 436, visiting the site after the site represented by the site representation 440).

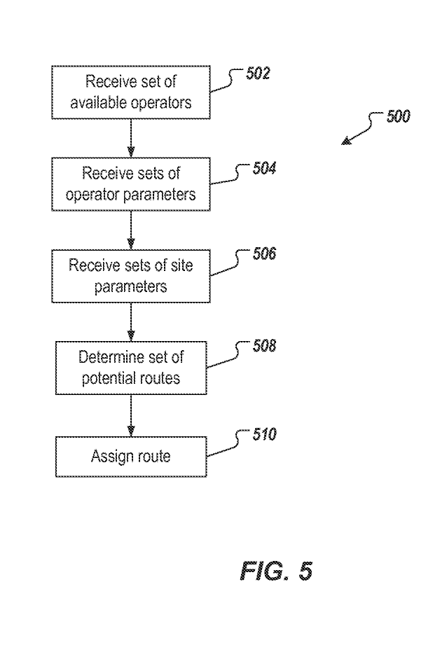

FIG. 5 depicts an example process 500 that can be executed in accordance with implementations of the present disclosure. In some examples, the example process 500 can be provided as one or more computer-executable programs executed using one or more computing devices. In some examples, the process 500 is executed to provide a route between sites.

A set of operators is received (502). For example, the computing cloud 107 of FIG. 1 can receive a set of operators. In some examples, the set of operators includes one or more operators that are available for site visits for a given time period (e.g., day, week, month). One or more sets of operator parameters are received (504). For example, the computing cloud 107 receives sets of operator parameters. In some examples, each set of operator parameters corresponds to a respective operator of the set of operators. Sets of site parameters are received (506). For example, the computing cloud 107 receives sets of site parameters. In some examples, each set of site parameters corresponds to a respective site of a set of sites. For each operator of the set of available operators, a set of potential routes is determined (508), and a route of the set of potential routes is assigned to a respective operator (510). In some examples, the set of potential routes is determined based on a respective set of operator parameters and the sets of site parameters, and each potential route of the set of potential routes is associated with a respective cost. In some examples, the route of the set of potential routes is assigned based on costs.

Implementations of the subject matter and the operations described in this specification can be realized in digital electronic circuitry, or in computer software, firmware, or hardware, including the structures disclosed in this specification and their structural equivalents, or in any appropriate combinations thereof. Implementations of the subject matter described in this specification can be realized using one or more computer programs, i.e., one or more modules of computer program instructions, encoded on computer storage medium for execution by, or to control the operation of, data processing apparatus, e.g., one or more processors. In some examples, program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. In some examples, the data processing apparatus can include special purpose logic circuitry, e.g., an FPGA (field programmable gate array) or an ASIC (application specific integrated circuit). In some examples, the data processing apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LED (light-emitting diode) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described.

Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for providing a route between sites, the method being executed using one or more processors and comprising:
receiving, by the one or more processors, a set of operators;
receiving, by the one or more processors, one or more sets of operator parameters, each set of operator parameters corresponding to a respective operator of the set of operators;
receiving, by the one or more processors, sets of site parameters, each set of site parameters corresponding to a respective site of a set of sites; and
for each operator of the set of operators:
determining, by the one or more processors, a set of potential routes based on a respective set of operator parameters and the sets of site parameters, each potential route of the set of potential routes being associated with a respective cost, and
assigning, by the one or more processors, a route of the set of potential routes to a respective operator based on at least one cost.

2. The method of claim 1, wherein operator parameters comprise one or more of a role, a skill set, a location, qualifications, and experience.

3. The method of claim 1, wherein site parameters comprise one or more of site location, site type, site equipment, site tasks, and site histories.

4. The method of claim 1, wherein one or more potential routes are provided based on ancillary information.

5. The method of claim 4, wherein ancillary information comprises weather information.

6. The method of claim 1, wherein assigning, by the one or more processors, a route of the set of potential routes to a respective operator based on costs comprises: determining a local optimization, and assigning the route based on the local optimization.

7. The method of claim 6, wherein the local optimization comprises identifying the route as being associated with a minimum cost in the set of potential routes.

8. The method of claim 1, wherein assigning a route of the set of potential routes to a respective operator based on costs comprises: determining a global optimization, and assigning the route based on the global optimization.

9. The method of claim 8, wherein the global optimization comprises identifying the route as contributing to a minimum cost across all assigned routes.

10. The method of claim 1, further comprising transmitting data and instructions to display a representation of the route on a device.

11. The method of claim 1, further comprising receiving data indicating progress along the route.

12. The method of claim 1, wherein the route of the set of potential routes is provided as a modified route in response to determining that one or more events have occurred.

13. The method of claim 1, wherein a cost associated with a potential route is based on one or more parameters of the set of operator parameters associated with the respective operator.

14. The method of claim 1, wherein costs are respectively provided as one or more of temporal cost and monetary cost.

15. The method of claim 1, wherein the set of available operators comprises one or more operators.

16. A non-transitory computer-readable storage medium coupled to one or more processors and having instructions stored thereon which, when executed by the one or more processors, cause the one or more processors to perform operations for providing a route between sites, the operations comprising:
receiving a set of operators;
receiving one or more sets of operator parameters, each set of operator parameters corresponding to a respective operator of the set of operators;
receiving sets of site parameters, each set of site parameters corresponding to a respective site of a set of sites; and
for each operator of the set of operators:
determining a set of potential routes based on a respective set of operator parameters and the sets of site parameters, each potential route of the set of potential routes being associated with a respective cost, and
assigning a route of the set of potential routes to a respective operator based on at least one cost.

17. A system, comprising:
a computing device; and
a computer-readable storage device coupled to the computing device and having instructions stored thereon which, when executed by the computing device, cause the computing device to perform operations for providing a route between sites, the operations comprising:
receiving a set of operators;
receiving one or more sets of operator parameters, each set of operator parameters corresponding to a respective operator of the set of operators;
receiving sets of site parameters, each set of site parameters corresponding to a respective site of a set of sites; and
for each operator of the set of operators:
determining a set of potential routes based on a respective set of operator parameters and the sets of site parameters, each potential route of the set of potential routes being associated with a respective cost, and
assigning a route of the set of potential routes to a respective operator based on at least one cost.
